(19) United States
(12) Patent Application Publication
(10) Pub. No.: US 2007/0016372 A1
(43) Pub. Date: Jan. 18, 2007

(54) Remote Perspective Vehicle Environment Observation System

(75) Inventors: Alan L. Browne, Grosse Pointe, MI (US); Osman D. Altan, Northville, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 11/427,818

(22) Filed: Jun. 30, 2006

Related U.S. Application Data
(60) Provisional application No. 60/699,349, filed on Jul. 14, 2005.

(51) Int. Cl. G01C 21/00

(52) U.S. Cl. 701/213; 701/200

(57) ABSTRACT

A system and method for enhancing situation awareness of a vehicle operator is disclosed. Object data corresponding to objects detected within a region external to the vehicle are determined from radar, imaging, GPS, and vehicle-to-vehicle communication systems. A three-dimensional visualization of the region is rendered on a visual display based on the object data including representations of detected objects and the vehicle from a viewpoint perspective that is remote from the vehicle.

### CROSS REFERENCE TO RELATED APPLICATIONS

This application claims priority from U.S. Provisional Application Ser. No. 60/699,349 filed Jul. 14, 2005.

### TECHNICAL FIELD

The present invention is related to vehicle operator situational awareness.

### BACKGROUND OF THE INVENTION

In automotive applications it is desirable to sense wide fields around the vehicle for pedestrians, vehicles, and other objects for use by the vehicle operator or automated vehicle systems in assessing the operational surroundings to provide for improved collision warning, avoidance, and mitigation. Obstacle detection and vehicle location relative to roads and obstacles provide the basis for enhanced situational awareness of the vehicle operator.

A variety of discrete systems exist which have the potential to improve a vehicle operator's situational awareness. Global positioning systems are known which can provide vehicle location information to aid in trip planning and routing. Imaging systems are known which can provide for limited fields of view, for example as a back-up aid, for pedestrian or obstacle detection, for lane departure warning, or for lane guidance in sophisticated automated highway applications. Radar, sonar and laser based systems are known which can provide for fore and aft obstacle detection and range/range-rate/angular position information relative to detected objects and are particularly useful in adaptive cruise controls and advance braking warning systems. Inter-vehicle and roadside-to-vehicle communication systems are being developed with ad-hoc wireless networking providing a basis for virtual distributed sensing, data exchange and advanced warning and collision mitigation/avoidance systems for improving transportation systems through the reduction of numbers and severity of collisions.

What is needed, however, is an integrated approach to operator situational awareness utilizing such various systems.

### SUMMARY OF THE INVENTION

A vehicle includes a situation awareness enhancement system. The system includes a radar system adapted for detecting objects in a region external to the vehicle so equipped and provides corresponding detected object data. The system also includes an imaging system adapted for detecting objects in the region external to the subject vehicle and provides corresponding detected object data. The system also includes a GPS system adapted for detecting objects in the region external to the subject vehicle and provides corresponding detected object data. Also included in the system are a visual display, which may include a head-up display, and a control unit which is adapted to receive detected object data from radar, imaging and GPS systems and to render a three-dimensional visualization of the region on the visual display. The rendered visualization includes detected objects and the vehicle from a viewpoint perspective that is remote from the vehicle. The system may further include a vehicle-to-vehicle communication system adapted for receiving detected object data from other vehicles in the region external to the subject vehicle. The viewpoint perspective may be selectively variable by the vehicle operator. Detected object data corresponding to the radar system may include one or more of range, range-rate and angular position data. The imaging system may be adapted for object recognition. And, the GPS system may be adapted for object identification.

A method for enhancing situation awareness of a vehicle operator includes providing object data corresponding to objects detected within a region external to the vehicle from a radar system, an imaging system, and a GPS system. A three-dimensional visualization of said region is rendered on a visual display based on the object data including representations of detected objects and the vehicle from a viewpoint perspective that is remote from the vehicle. Rendering the three-dimensional visualization may be done in accordance with an operator selected viewpoint perspective. The method may further include providing object data corresponding to objects detected within said region external to the subject vehicle from a vehicle-to-vehicle communication system. The method may further include fusing the object data corresponding to detected objects and rendering the three-dimensional visualization of said region on a visual display is based on the fused object data. Object data corresponding to the radar system may include one or more of range, range-rate and angular position data. Object data corresponding to the imaging system may include object recognition data. And, object data corresponding to the GPS system may include object identification data.

### BRIEF DESCRIPTION OF THE DRAWINGS

FIG. 1 illustrates in block diagram format a vehicle environment observation system in accordance with various possible configurations of the present invention;

FIG. 2 is a simulation plot and representative visualization display of a minimally configured vehicle environment observation system in accordance with the present invention; and

FIG. 3 illustrates a representative visualization display of an alternatively configured vehicle environment observation system in accordance with the present invention.

### DESCRIPTION OF THE PREFERRED EMBODIMENT

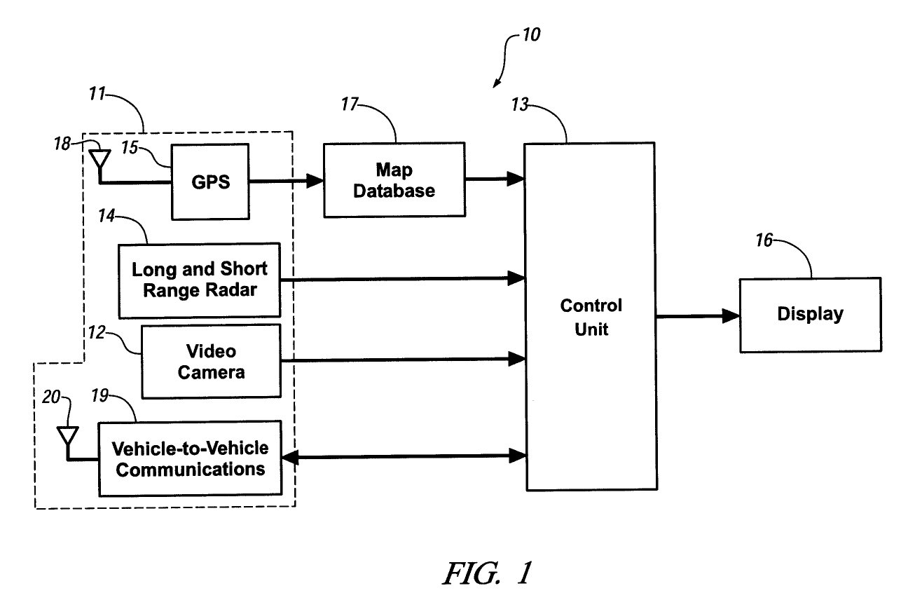

With reference first to FIG. 1, a vehicle environment observation system 10 is schematically shown. A road vehicle (not shown) also referred to as the subject vehicle, for example a passenger car, includes a plurality of sensing systems 11 for providing a variety of data related to the vehicle's surroundings or environment. Signals and data from the sensing systems are provided to a computer based control unit 13. Control unit 13 may include single or multiple controllers operating independently or in a cooperative or networked fashion and comprise such common elements as a microprocessor, read only memory ROM, random access memory RAM, electrically programmable read only memory EPROM, high speed clock, analog to digital (A/D) and digital to analog (D/A) circuitry, and input/output circuitry and devices (I/O) and appropriate signal conditioning and buffer circuitry. Control unit 13 may be associated with vehicle dynamics data processing including for example, real time data concerning vehicle velocity, acceleration/deceleration, yaw, steering wheel position, brake and throttle position, and the transmission gear position of the vehicle. Control unit 13 has stored therein, in the form of computer executable program code, algorithms for effecting steps, procedures and processes related to the present invention.

Proceeding with the hardware description, a first sensing system includes an imaging system 12 of one or more video cameras or other similar imaging apparatus including, for example, infrared and night-vision systems, or cooperative combinations thereof for real time object detection. As used herein, the term imaging system includes, for example, imaging apparatus such as video cameras, infrared and night-vision systems. Exemplary imaging hardware includes a black and white or color CMOS or CCD video camera and analog-to-digital converter circuitry, or the same camera system with digital data interface. Such a camera is mounted in an appropriate location for the desired field of view which preferably includes a frontal field of view, and which may further include rear and generally lateral fields of view. It is ideal for applying the present invention to the most diverse situational awareness applications (e.g. forward vehicle travel, back-up assist, perimeter security, etc.), that a full 360 degree field be sensed and therefore it is to be understood that multiple position sensors may be situated at various different points along the perimeter of the vehicle to thereby facilitate imaging of objects from any direction. It is to be understood, however, that partial perimeter coverage is completely acceptable and may, in fact, be preferred from a cost/benefit perspective of the vehicle manufacturer in implementing production systems. Imaging system 12 preferably includes object recognition functionality including, for example: road feature recognition such as for lane markers, shoulder features, overpasses or intersections, ramps and the like; common roadside object recognition such as for signage; and, vehicle recognition such as for passenger cars, trucks and other reasonably foreseeable vehicles sharing the roads with the subject vehicle. Such sensing systems are effective at providing object detection particularly with respect to azimuth position and, with proper training, deterministic object recognition. Also known are single camera image processing systems that can estimate range and range-rate of objects in addition to angular position. Stereo imaging systems are capable of accurately determining the range of objects and can compute range-rate information also. Color camera systems determine the color of the objects/vehicles in the field of view and can be used in rendering objects in corresponding colors when presented on the display. This will reduce the workload on the driver in relating the objects on the display with the objects in his/her visual field.

Another sensing system includes one or more radar, sonar or laser based systems 14 for real-time object detection and range/range-rate/angular position information extraction. As used herein, the term ranging system includes, for example, any adaptable detection and ranging system including, for example, radar, sonar or laser based systems (e.g. LIDAR/LADAR). A ranging system may even include an imaging system with similar capabilities as discussed in further examples herein above. Although other conventional types of sensors may be used, sensing system 14 preferably employs either an electromagnetic radar type sensor, a laser radar type sensor, or a pulsed infrared laser type sensor. The sensor or sensor array is preferably situated at or near the perimeter of the vehicle to thereby facilitate optimal line-of-sight position sensing when an object comes within sensing range and field of the subject vehicle perimeter. Again, it is ideal for applying the present invention to the most diverse situational awareness applications that a full 360 degree field be sensed and therefore it is to be understood that multiple position sensors may be situated at various different points and orientations along the perimeter of the vehicle to thereby facilitate sensing of objects, their ranges, range-rates and angular positions from any direction. It is to be understood, however, that partial perimeter coverage is completely acceptable and may, in fact, be preferred from a cost/benefit perspective of the vehicle manufacturer in implementing production systems. Such sensing systems are effective at providing discrete object detection, detected object positional information with respect to the subject vehicle and absolute and relative object motion information. However, such sensing systems are not generally associated with deterministic object recognition though object recognition may be inferentially determined.

Another sensing system includes a global positioning system. GPS system includes global positioning GPS 15 and a database 17 containing detailed road and highway map information in the form of digital map data. GPS 15 enables a vehicle to obtain real time vehicle position data from GPS satellites in the form of longitude and latitude coordinates. Database 17 provides detailed information related to road and road lanes, identity and position of various objects or landmarks situated along or near roads and topological data. Some of these database objects may include, for example, signs, poles, fire hydrants, barriers, bridges, bridge pillars and overpasses. In addition, database 17 utilized by GPS 15 is easily updateable via remote transmissions (for example, via cellular, direct satellite or other telematics networks) from GPS customer service centers so that detailed information concerning both the identity and position of even temporary signs or blocking structures set up during brief periods of road-related construction is available as well. An example of one such customer service center includes the OnStar system. Such sensing systems are useful for constructing road images and fixed structures on or near the road and overlaying same relative to the subject vehicle position. GPS 15 is therefore appreciated for particular utility with respect to reduced visibility driving conditions due to weather or ambient lighting which may also have a deleterious affect other sensing systems.

GPS 15 includes a receiver and an antenna

obtaining real time vehicle position data from global positioning system satellites. As illustrated, GPS 15 and map database 17 are coupled to the control unit 13 and provide control unit 13 with access to the real time vehicle position data and the digital map data. As used herein, the term GPS system includes GPS 15 and database (e.g. database 17).

Another sensing system includes a vehicle-to-vehicle communications system 19. Communications system 19 communicates with other vehicles within a limited range or field, also referred to as object vehicles, having a similar compatible communications system. Such systems may be better known to those skilled in the art as dedicated short range communications (DSRC). In this way, both the subject vehicle and the object vehicles can transmit and receive respective vehicle data including size, vehicle dynamics data (e.g. speed, acceleration, yaw rate, steering wheel/tire angle, status of brake pedal switch, etc.) and positional data to and from each other via their respective communications system. Additionally, the field of available vehicle data may be extended through data passing in, conceptually, “bucket brigade” fashion for effective range extension of such communications.

Vehicle-to-vehicle communications system 19 includes a transmitter, a receiver and a communications antenna. The communications antenna is preferably a directional-type antenna 20. The communications system 19 is coupled to the control unit 13 to enable the transfer of subject vehicle dynamics data and subject vehicle size, type and other characteristic data to the object vehicle via the communications system 19. And, the communications system 19 is coupled to the control unit 13 to enable the transfer of object vehicle dynamics data and object vehicle size, type and other characteristic data to control unit 13 of the subject vehicle as received from the object vehicle via the communications system 19.

Display 16 is also coupled to control unit 13 and provides the subject vehicle operator with a visual representation or rendering of the surrounding subject vehicle environment. Display 16 may take the form of a conventional CRT or flat panel display preferably integrated into the vehicle instrument panel. Alternatively, the display may take the form of a head-up display which projects the image to be displayed against the windshield of the vehicle for reflective display to the vehicle operator in a field of view substantially in line of site with the road and preferably adjustable to the preferences of the vehicle operator. Still other implementations of the display may include flip-out arrangements or integrations within headliners, sunvisors and the like.

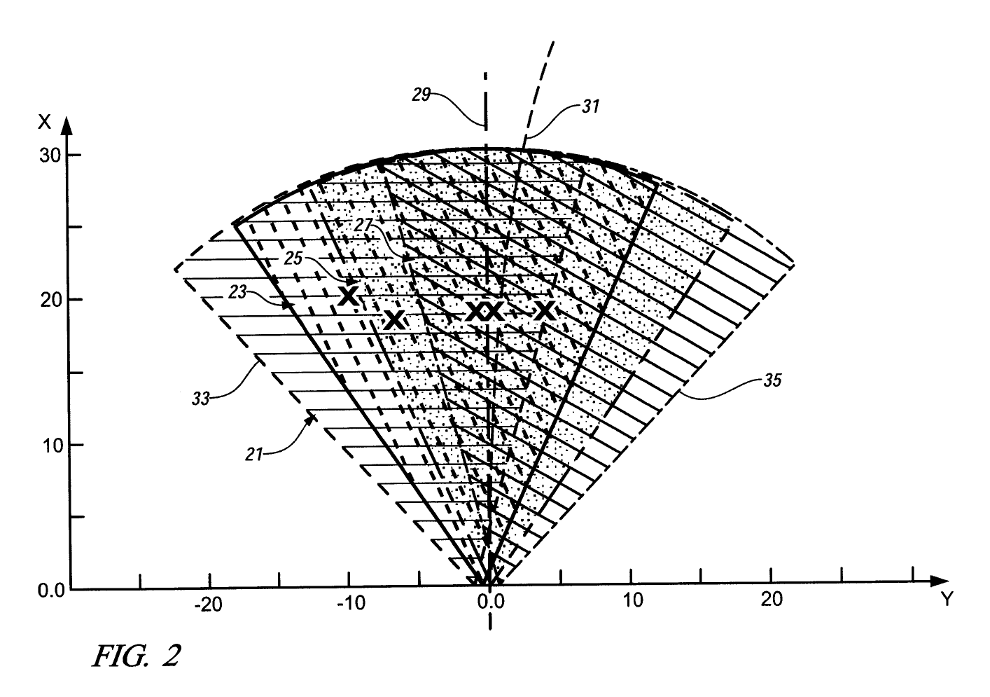

A minimally configured system in accordance with the present invention would include at least one sensing system providing positional data of objects in the vicinity of the vehicle and within the field sensing capabilities, including peripherally (e.g. side-to-side) and longitudinally (e.g. range) relative to the sensor system. FIG. 2 represents a simulation of an exemplary vehicle environment observation system employing four discrete radar sensing systems distributed across the frontal area of the subject vehicle and characterized by generally forward looking fields as represented by overlapped peripherally limited fields 21-27. Each of the radar systems may further be characterized by an effective longitudinal range generally categorized as short or long. The front of the vehicle is located substantially at the origin of the plot (0.0). The vehicle is longitudinally aligned along an axis 29 intersecting the origin. The X-Y axes of the plot are quantized in meters with the Y axis values representing lateral position relative to the subject vehicle longitudinal centerline and the X axis values representing longitudinal position relative to the subject vehicle frontal area. In the plot of FIG. 2 are shown various (X) which represent detected object positions. For example, the left-most detected object position (X) is substantially 10 meters to the left of the subject vehicle centerline and 20 meters to the front of the subject vehicle. Such object detections are the result of individual sensor detections and combined or fused sensor detections. One skilled in the art will recognize the value in data fusion in validating the object detections of independent sensing systems. Of course, the plot of FIG. 2 represents a temporal snapshot of the detected objects and the relative positions (X) of detected objects may change over time as the objects move, the subject vehicle moves or both. Therefore, object trajectory data, both historical and predictive, relative to the subject vehicle may be determined through well known time varying techniques. Such data is useful in predicting subject vehicle collisions with detected objects or even object-to-object collisions. Also shown in the plot of FIG. 2 is a predicted trajectory 31 of the subject vehicle based upon well known vehicle dynamics sensed and controlled quantities including, for example, longitudinal and lateral velocity and acceleration, yaw, understeer/oversteer, steering wheel angle, brake effort, wheel torque, individual wheel speeds and stability controls among others. This trajectory, too, is useful in predicting subject vehicle collisions with detected objects.

The present invention, however, in addition to being fully capable of providing the benefits of a collision warning system, provides the vehicle operator with a virtual view of objects detected relative to the subject vehicle. Moreover, unlike a conventional camera based system providing substantially unprocessed video images to a display for the use by the vehicle operator, the present invention provides for the vehicle operator a remote perspective view of the vehicle surroundings or environment. In the present example with respect to FIG. 2, the display may simply provide an image substantially in accordance with the figure. That is to say, a field may be delimited by the extreme region limits at 33 and 35, and the detected objects therein may be simply displayed in a two-dimensional visualization. Significantly, however, the perspective provided to the vehicle operator is with respect to a detached, remote observation point, in this example in FIG. 2 substantially directly above the vehicle and observation environment. Various modifications to the precise manner of display will provide improved perception by the vehicle operator and may include iconic or graphic overlays representing the subject vehicle and detected objects, or attention enhancing features such as flashing graphics, animations, color/meaning combinations, etc. The detected objects, for example, may be overlayed with vehicular icons or graphics including colors that matches the actual colors of objects/vehicles where, in the present exemplary radar based system, such inferential object identifications can be made. Additionally, collision threat level may be conveyed by flashing an icon, periodically changing the color of the icon, etc. It can be appreciated that the just described minimally configured system may be implemented, for example with a video camera based system and some level of object recognition. However, it will similarly be appreciated that such implementation are generally limited by the line of site characteristics of such sensing schemes and hence provide for relatively limited sensed surroundings or environments.

Moreover, the present invention provides for variable perspective vantage points and three-dimensional visualizations of the surroundings in analogous fashion to a third person view or perspective provided in some video games. The vehicle operator is provided with the ability to change the viewing angles in a three-dimensional coordinate system. In certain situations, for example for monitoring perimeter security, it may be advantageous to take a substantially top-down, birds-eye, plan view of the surroundings, substantially in accordance with the perspective afforded in FIG. 2. In other situations, for example monitoring preceding freeway traffic, it may be advantageous to take a more acute view of the surroundings from above and behind the subject vehicle including lateral offsets (i.e. left or right) as desired. Three-dimensional graphic rendering may be performed in minimally configured systems from standard graphic library elements, for example general vehicle representation graphics including color matching of actual objects. Again, however, it is appreciated that line of site sensing system implementations provide for relatively limited sensed surroundings or environments.

In accordance with alternatively configured systems, the field or sensed surroundings can be significantly enhanced by the addition of other sensing systems including, individually or in combination, vehicle-to-vehicle communications systems and GPS. Furthermore, GPS with map database systems enable significant enhancements to the visualization provided to the vehicle operator as described further herein below.

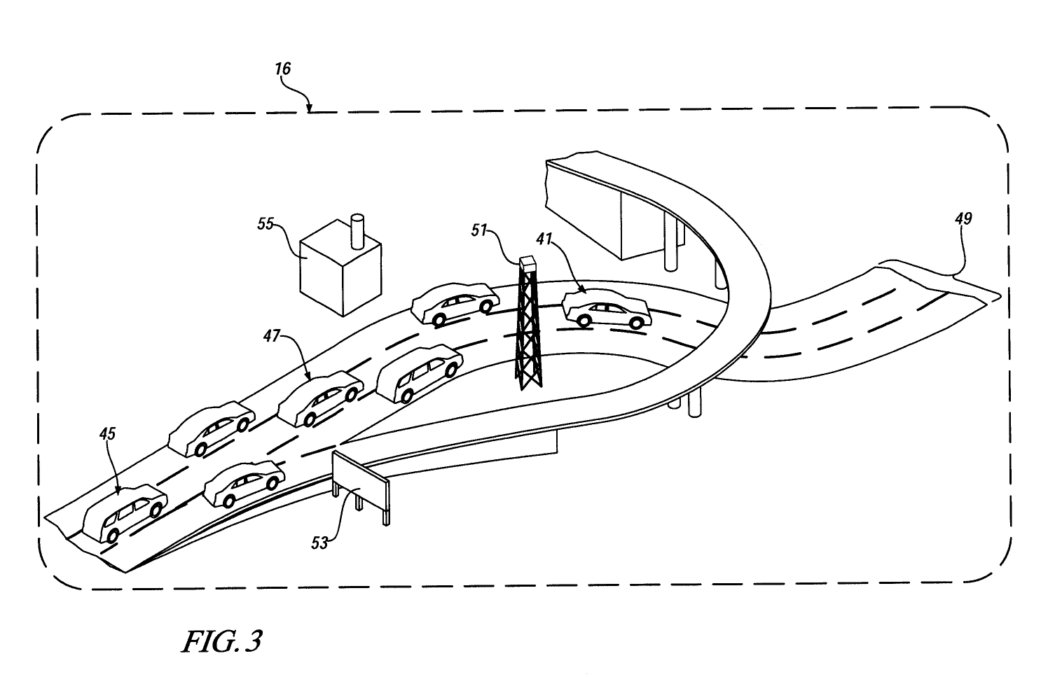

Additional reference is now made to FIG. 3 wherein the subject vehicle is labeled with the reference number 45. In the present FIG. 3, the exemplary view is substantially from above, to the rear and with a lateral offset relative to the subject vehicle 45. First, vehicle-to-vehicle communications systems alone provide for enhancements relative to object identification. Vehicle-to-vehicle communications systems' provision of object vehicle identification allows for improved graphical representations of the object vehicle including size and type and realistic graphic representation through stored library data and three dimensional renderings in a three-dimensional visualization. Vehicle-to-vehicle communications systems as well provide object vehicle dynamics information for complementing, for example, range and range-rate information obtained from line of site sensing systems. This can be particularly useful in situations where line of site data is temporarily interrupted such as during travel on hilly terrain, or where one object vehicle 47 displaces another object vehicle 41 such as in a cut-in situation. GPS employed in object vehicles also having vehicle-to-vehicle communications systems significantly enhances the surroundings by enabling the conveyance of real time position data of object vehicles to the subject vehicle for building the surroundings visualization. GPS employed in the subject vehicle 45 significantly enhances the surroundings representation by providing data from which roadway overlays, representations and renderings, including, for example, lane demarcations, intersections, roadside obstacles (e.g. cellular communications tower 51, road sign 53, building 55) may be included in the graphical representation or visualizations provided to the vehicle operator via the display.

It is therefore appreciated that a more generously configured vehicle in terms of peripheral coverage from sensor positional diversity or from sensing system topological diversity yield a more robust and capable system. Data fusion from topologically diverse sensing systems allows for redundancy and robust object detections and validation and substantially 360 degree data thus enabling visualizations of complete:vehicle perimeters.

The invention has been described with specific reference to the preferred embodiments and modifications thereto. Further modifications and alterations may occur to others upon reading and understanding the specification. It is intended to include all such modifications and alterations insofar as they come within the scope of the invention.

1. Situation awareness enhancement system for a subject vehicle comprising:
a ranging system adapted for detecting objects in a region external to the subject vehicle and for providing corresponding detected object data;
an imaging system adapted for detecting objects in said region external to the subject vehicle and for providing corresponding detected object data;
a GPS system adapted for detecting objects in said region external to the subject vehicle and for providing corresponding detected object data;
a visual display; and,
a control unit adapted to receive detected object data from ranging, imaging and GPS systems and render a three-dimensional visualization of said region on the visual display including detected objects and the subject vehicle from a viewpoint perspective that is remote from the subject vehicle.

2. The situation awareness enhancement system for a subject vehicle as claimed in claim 1 further comprising:
a vehicle-to-vehicle communication system adapted for receiving detected object data from other vehicles in said region external to the subject vehicle;
wherein said control unit is further adapted to receive detected object data from said vehicle-to-vehicle communication system for use in rendering said three-dimensional visualization of said region.

3. The situation awareness enhancement system for a subject vehicle as claimed in claim 1 wherein the viewpoint perspective is selectively variable.

4. The situation awareness enhancement system for a subject vehicle as claimed in claim 1 wherein detected object data corresponding to the ranging system includes one or more of range, range-rate and angular position data.

5. The situation awareness enhancement system for a subject vehicle as claimed in claim 1 wherein the imaging system is adapted for object recognition.

6. The situation awareness enhancement system for a subject vehicle as claimed in claim 1 wherein the GPS system is adapted for object identification.

7. The situation awareness enhancement system for a subject vehicle as claimed in claim 1 wherein the visual display comprises a head-up display.

8. The situation awareness enhancement system for a subject vehicle as claimed in claim 1 wherein the ranging system includes one or more of a radar system, a ladar system, a lidar system, a sonar system and an imaging system.

9. The situation awareness enhancement system for a subject vehicle as claimed in claim 1 wherein the detected objects are rendered for display in colors substantially corresponding to the actual colors of the detected objects.

10. Method for enhancing situation awareness of a subject vehicle operator, comprising:
providing object data corresponding to objects detected within a region external to the subject vehicle from a ranging system, an imaging system, and a GPS system; and,
rendering a three-dimensional visualization of said region on a visual display based on the object data including representations of detected objects and the subject vehicle from a viewpoint perspective that is remote from the subject vehicle possibly with color matching the actual color of the object/vehicle.

11. The method for enhancing situation awareness of a subject vehicle operator as claimed in claim 10 further comprising:
providing object data corresponding to objects detected within said region external to the subject vehicle from a vehicle-to-vehicle communication system.

12. The method for enhancing situation awareness of a subject vehicle operator as claimed in claim 10 further comprising:
fusing the object data corresponding to detected objects;
wherein rendering the three-dimensional visualization of said region on a visual display is based on the fused object data.

13. The method for enhancing situation awareness of a subject vehicle operator as claimed in claim 10 wherein object data corresponding to the ranging system includes one or more of range, range-rate and angular position data.

14. The method for enhancing situation awareness of a subject vehicle operator as claimed in claim 10 wherein object data corresponding to the imaging system includes object recognition data.

15. The method for enhancing situation awareness of a subject vehicle operator as claimed in claim 10 wherein object data corresponding to the GPS system includes object identification data.

16. The method for enhancing situation awareness of a subject vehicle operator as claimed in claim 10 wherein rendering a three-dimensional visualization of said region on a visual display is done in accordance with an operator selected viewpoint perspective.

17. The method for enhancing situation awareness of a subject vehicle operator as claimed in claim 10 wherein rendering a three-dimensional visualization of said region on a visual display based on the object data includes rendering the detected objects in colors substantially corresponding to the actual colors of the detected objects.
